(19) United States
(12) Patent Application Publication
(10) Pub. No.: US 2001/0053252 A1
(43) Pub. Date: Dec. 20, 2001

(54) Method of knowledge management and information retrieval utilizing natural characteristics of published documents as an index method to a digital content store

(76) Inventor: Stuart Creque, Moraga, CA (US)

Correspondence Address: Andrew V. Smith, Sierra Patent Group, P.O. Box 6149, Stateline, NV, 89449, US

(21) Appl. No.: 09/882,688

(22) Filed: Jun. 13, 2001

Related U.S. Application Data
(60) Provisional application No. 60/211,062, filed on Jun. 13, 2000.

(51) Int. Cl. G06K 9/54; G06K 9/60

(52) U.S. Cl. 382/305

(57) ABSTRACT

A software program running on a content server computer having access to a content repository provides instructions for one or more processors of the server computer to receive a content retrieval request in the form of a digital data representation of at least one physical feature of the requested content captured from the document by a data capture device, parsing the data to identify the content from the digital data representation, retrieving the content from the content repository, comparing the content retrieved to the at least one physical feature of the content requested, extracting the content requested from the content retrieved, and responding to the content retrieval request.

### PRIORITY

This application claims the benefit of priority to U.S. provisional patent application No. 60/211,062, filed Jun. 13, 2000.

### BACKGROUND OF THE INVENTION

1. Field of the Invention

The invention relates to digital content storage and retrieval, and particularly to management of a digital content store by indexing documents based on digital representations of physical document characteristics.

2. Discussion of the Related Art

NeoMedia uses technology relating to means of retrieving document content identified by a unique bar code identifier published within the document. Their method relies on the publisher adding a unique, machine readable code into each article or other component of the document. Aside from necessitating changes to the actual printed content of the document, this requires central administration of the bar code identifiers so that no two publishers assign the same ID to two different articles.

Digimarc Corporation has a technology called MediaBridge to use “digital watermarks” that must be embedded in the document as means for linking to a Web address where the document may be stored. The watermarks, originally developed for anti-counterfeiting applications, must be read with special scanning equipment. GoCode and Intacta use similar technology in the form of two-dimensional bar codes that compress more data into comparable page areas than conventional bar codes.

### SUMMARY OF THE INVENTION

In view of the above, a software program running on a content server computer having access to a content repository provides instructions for one or more processors of the server computer to receive a content retrieval request in the form of a digital data representation of at least one physical feature of the requested content captured from the document by a data capture device, parsing the data to identify the content from the digital data representation, retrieving the content from the content repository, comparing the content retrieved to the at least one physical feature of the content requested, extracting the content requested from the content retrieved, and responding to the content retrieval request.

A method of retrieving content from a content repository includes capturing at least one physical feature of a requested content with a data capture device, uploading a digital representation of the at least one physical feature of the requested content to a personal computing device, sending a request over a network to a content server having access to a content repository, which content server retrieves the content from the content repository, and receiving a response from the server including the requested content.

A software program running on a personal computing device having access to a network provides instruction for uploading a digital representation of at least one physical feature of a requested content from a data capture device, sending a request over a network to a content server having access to a content repository, which content server retrieves the content from the content repository, and receiving a response from the server including the requested content.

A method of storing and indexing a content repository includes the operations indexing content according to physical features of the content, and storing the content in the content repository, wherein the content is unencoded with any document identifier other than the physical features of the content.

A method of retrieving content from a content repository includes the operations receiving a content retrieval request in the form of a digital data representation of at least one physical feature of the requested content and captured from the document by a data capture device, parsing the data to identify the content from the digital data representation, retrieving the content from the content repository, comparing the content retrieved to the at least one physical feature of the content requested, extracting the content requested from the content retrieved, and responding to the content retrieval request.

### BRIEF DESCRIPTION OF THE DRAWINGS

FIG. 1 illustrates a system architecture in accord with a preferred embodiment.

FIG. 2 illustrates capture of a physical characteristic of a document in accord with a preferred embodiment.

FIG. 3 illustrates initial upload to a personal computing device of document data captured within a data capture device in accord with a preferred embodiment.

FIG. 4 illustrates upload to a server of data initially uploaded to a personal computing device in accord with a preferred embodiment.

FIG. 5 illustrates receipt of data at a server in accord with a preferred embodiment.

FIG. 6 illustrates response document delivery to the personal computing device in accord with a preferred embodiment.

### DETAILED DESCRIPTION OF THE PREFERRED EMBODIMENTS

It is recognized herein that a published document is a fixed form of expression that can be thought of as “fossilized information.” This is indeed the principle that enables printed documents to have valid tables of contents and indexes; if the content of the printed page were able to shift position from page to page (as the content of a HTML document on a Web browser screen does, for example), a printed table of contents or index would become useless.

Interestingly, the reverse relationship holds. Finding a word on a particular page of a book would, with the proper technology, allow the reader to find the corresponding index entry. Of more practical use, finding a keyword, key phrase, or graphic element (even an X-Y coordinate position) on a known page of a known edition of a document will, with the proper technology, act as an unambiguous pointer or index to the content of the document, allowing the user to retrieve the marked article, illustration, or text excerpt.

An important practical aspect of this principle is that there does not need to be any special programming or coding to achieve this reverse indexing; it is inherent in the fact that the document is printed and therefore in a fixed form. The characteristic elements of a printed document such as a book, published article or even advertisement are fixed in position within a given edition of the document, just as a fossil is in a fixed position in the Earth's crust. These characteristics include:

Headline

Byline

First line of article text

Figure number and/or caption

Keyword or key phrase

Page location (i.e., X-Y coordinates on page of start of article and/or end of article, or polygon outline of article boundaries

These characteristics are part of an overall hierarchy of document identification that, using a periodical as an example, includes:

1. Name of publication

A. Edition of publication (e.g., East Coast vs. West Coast)

1. Volume and issue number of publication (and/or issue date)

a) Page on which characteristic is found

(1) Characteristic, comprising:

(a) Characteristic type (e.g., text string, X-Y coordinates, etc.)

(b) Characteristic value(s)

As long as the values for the first four levels of the hierarchy (i.e., publication, edition, volume & issue, and page) are known, one simple characteristic is generally sufficient to unambiguously identify the article in question. Sometimes just the page number is sufficient, as a page in a publication is often occupied by only one article or advertisement. If the page number is insufficient, an unambiguous identification can generally be made on the basis of one significant characteristic, with two required in rare instances.

A preferred embodiment is described herein for using digital technology to create and maintain a digital representation of a published document in such a manner that the physical characteristics of the document are mapped to the digital representation, and for capturing document characteristics using an input device. Documents can be stored in a database and retrieved based on one or more of these characteristics, thereby obviating the use of additional barcodes or watermarks. Also, parts of a document can be retrived, and user notes can also be retrieved along with a document a user has already worked on. A user may also go directly to a desired location in a document.

In accord with the preferred embodiment, digital technology is used to create and maintain a digital representation of a published document in such a manner that the physical characteristics of the document are mapped to the digital representation. A layout-preserving manner of encoding, such as the Adobe Portable Document Format (PDF), is preferably used to provide a full and unambiguous mapping of the physical document to the digital content. A simple text file, a word processing document, or even an HTML file containing the exact text and illustrations in a document structure would not suffice for this purpose, as the layout and page positions of the content for these digital document types can vary depending on the device used to render them. PDF has the property that its content will always be laid out in the same position regardless of the rendering method.

For this reason, it is possible to match a captured document characteristic on a known page in a known printed document to the same characteristic in that document's PDF representation. If the characteristic is a word, phrase or string, it can be matched to the characters on that page of the PDF version. If the characteristic is a coordinate point, a line or a polygon, its position and extent can be mapped to the same regions of the PDF representation.

PDF includes linking methods to allow an article's constituent parts to be chained together from start to finish, to allow a headline, caption or even picture to link to other content in the document, and even to allow links from the document content to content outside the document, including URLs for the World Wide Web. Thus once a characteristic has been captured and mapped to a place in the PDF document, it can also map (via links) to other parts of that document or to any other information on the Web.

Note that the function of PDF for printed documents can be met by standard formats for storage of audio, video and still image “documents.” So long as these are stored in a format that allows for consistent reconstruction of the content, they can serve as maps using features such as time codes, geometric positions, or image or audio samples.

Also in accord with the preferred embodiment, document characteristics may be captured using an input device. A preferred device may include one of the following technologies (but certainly not limited thereto):

(a) handheld OCR wand that reads words, phrases and lines of text from a printed page;

(b) handheld image scanner that captures image segments (typically in strips) from a printed page;

(c) digitizing tablet (can be desktop-fixed or independently portable, such as the CrossPad) that captures coordinates, lines, curves and polygons from a printed page, and that can in some instances capture text via handprint recognition or alphanumeric touchpad;

(d) digital voice recorder that captures verbal description of characteristics, coupled with automated voice recognition to convert verbal observations into data about characteristics;

(e) telephony interface that permits verbal and/or touch-tone capture of characteristics from a telephone, including a handheld cellular or PCS phone;

(f) an ordinary pen or highlighting marker, followed by image scanning with a page scanner or even a simple video camera to locate the position of the markings on the page.

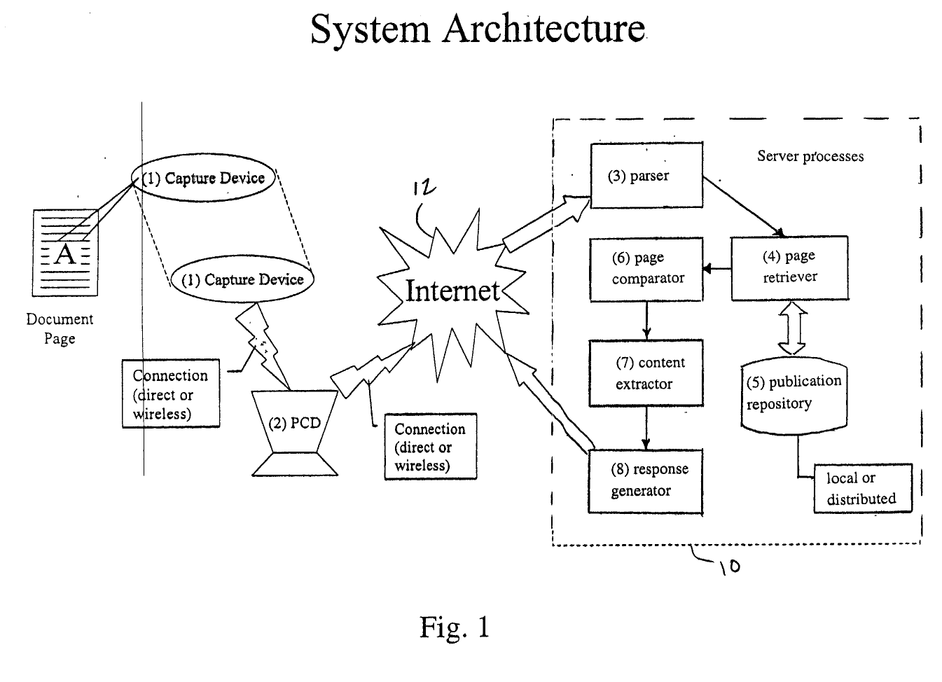

Referring now to FIG. 1, a system architecture according to a preferred embodiment includes a capture device 1, a personal computer device 2 as well as software modules including a parser 3, a page retriever 4, a publication repository 5, local and/or distributed, as shown, a page comparator 6, a content extractor 7 and a response generator 8. The software modules 3-4 and 6-8 are preferably stored on a server computer 10, as may be the publication repository 5, which as suggested may additionally or alternatively include a distributed network. The server computer 10 preferably communicates over a network 12 such as the internet with the personal computer device 2.

The repository 5 of digital documents may be stored in a layout-preserving format (e.g., PDF) and indexed according to a hierarchy, e.g., {Name of Publication <with> Edition <with> Volume and Issue Number or Issue Date } for each digital document file in a 1:1 relationship. The repository 5 may be a centralized repository and/or it may include distributed repositories of individual publishers with a central indexing and access method that allows retrieval of any extant document file in response to a valid query.

Methods of adding documents to the repository 5, which include (a) using a layout-preserving file furnished by the publisher, (b) translating a set of non-layout-preserving content data into a layout-preserving file that matches the published document, and (c) using a hardcopy of the published document as the source material for a conversion process that creates a matching, layout-preserving digital file. This method preferably includes updating the central index for the document repository 5.

Methods for an end user to capture codes for simple article characteristics with minimal effort yet with unambiguity may include, but are not limited to:

a) capture of graphical coordinate and/or polygon data corresponding to page position, as with a digitizing tablet;

b) capture of a scanned image of part of the article;

c) capture of a text fragment from the article, using a handheld OCR device such as an OCR wand; and

d) capture of text fragments and/or coordinate data from the article via manual transcription as with a personal digital assistant (e.g., Palm Pilot™) via the writing stylus, or as with a “palmtop” computer or other text capture device via a keypad, or as with a voice recording device.

Each of the foregoing methods preferably includes means for capturing the document index data (publication, issue, edition) as well as page number in order to create a complete and unambiguous mapping to the stored article.

Methods for uploading the data captured by the various types of characteristic capture devices 1 to a personal computer 2 to permit automated analysis, extraction and translation of the coded data preferably work in tandem with a Web browser to automate the upload of raw data from the handheld device 1 to the PC 2 and preprocessed data from the PC 2 to a web site, so that overall the desired articles are retrieved automatically.

Methods for translating the codes captured by the end user into the corresponding characteristics of the desired articles in the correct documents may include, but are not limited to:

a) geometric analysis of captured coordinate and polygon data to recognize corresponding features in the article layout, such as positions of paragraphs and illustrations on the page, and allowing for designation of other characteristics such as keywords via underlining or circling;

b) image feature analysis to extract text strings (via OCR) and layout information (e.g., paragraph and text line boundaries) from scanned images of article fragments, so that the fragments map to the digitally stored article;

c) text feature analysis to map text strings captured by an OCR wand to the corresponding article in the digital repository; and

d) stylus-to-text and voice-to-text conversion software, as well as analysis of key-entered data, to ensure that the encoded characteristics are properly decoded.

Each of the foregoing methods is preferably paired with another method of capturing the publication/issue number or issue data/edition date, such as by direct key entry or stylus transcription, in order to create a complete and unambiguous document index path.

Software for management of the retrieved article (text plus embedded images) to permit routing, filing, and extracting content from the retrieved article file preferably includes software at the end user PC 2 for local content management and software at the web server 10 to perform the same tasks on a shared basis in an Application Services Provided (ASP) mode.

There are many advantages offered by the preferred embodiment herein. For example, the disclosed method allows a publication to offer users linking capabilities without any changes to the printing process. The disclosed method allows a publication to offer users linking capabilities without sacrificing any layout space that would otherwise be used for content or advertising, and without having to incorporate any graphic elements that disrupt or impact the visual style of the publication. The disclosed method allows the user to link to online content in a variety of ways, including such ad hoc methods as keyword searching, and does not require the publication to select and explicitly encode links that require deliberate information design and that may be subject to coding errors. The disclosed method offers greater functionality and flexibility with less production cost than competing methods.

The disclosed method allows end users to use printed documents as indexes to digital content, most typically stored on the Internet and World Wide Web, and thereby (1) to mark and “clip” articles for automatic retrieval and later use, and (2) to link to Web content explicitly or implicitly cited in the documents. By exploiting the fixed relationship between a physical printed page and its virtual representation, end users can use hand-held instruments to capture features of printed pages and then employ a computerized process that automatically maps the captured features to the stored representation of the corresponding document elements. This allows users to rapidly “highlight” articles and illustrations, even words and phrases, with simple instruments and still achieve full-fidelity retrieval from the stored version. This also allows users to employ “hyperlinks” within the printed document, both to follow articles sequentially from beginning to end and to link to material outside the document itself. The method is generally applicable to other forms of content, such as images, video and audio, by using such features as time ranges, geometric positions and image or audio content samples to map into the fixed content.

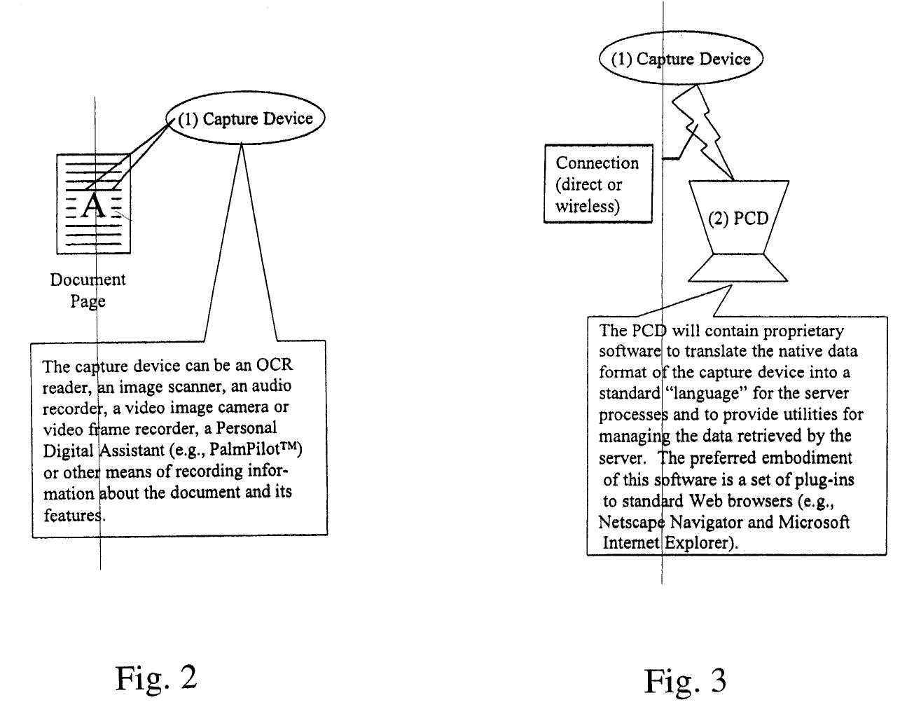

FIG. 2 illustrates capture of a physical characteristic of a document in accord with a preferred embodiment. As shown, the capture device 1 can be an OCR reader, an image scanner, an audio recorder, a video image camera or video frame recorder, a personal digital assistant (PDA) or other means of recording information about the document and its features. The hand-held capture device 1 is initially set by the user for a specific publication, issue and/or edition. On noting an item of interest, the user preferably captures the page number and then captures an item feature (e.g., keyword or image fragment). Multiple items per page can be captured. Capture can also apply to audio or video information within a given program (vs. document).

FIG. 3 illustrates initial upload to a personal computing device 2, or PCD 2, of document data captured within a data capture device 1 in accord with a preferred embodiment. As shown, the PCD 2 preferably contains proprietary software to translate the native data format of the capture device 1 into a standard language for the server processes (see FIG. 1) and to provide utilities for managing the data retrieved by the server 10. The preferred embodiment of this software includes a set of plug-ins to standard web browsers (e.g., Netscape Navigator and Microsoft Internet Explorer). the data in the hand-held capture device 1 is uploaded to a personal computing device 2 that is connected to a network 12 such as the internet, a wide area network or otherwise. The PCD 2 may be a personal computer, a personal digital assistant (PDA), a network computing device (NCD), or a purpose-built network port, or another computing and/or web-enabled device. It It may in fact be incorporated into the capture device 1 itself, e.g., if the capture device 1 is a PDA or other wireless device or device have wireless connectivity.

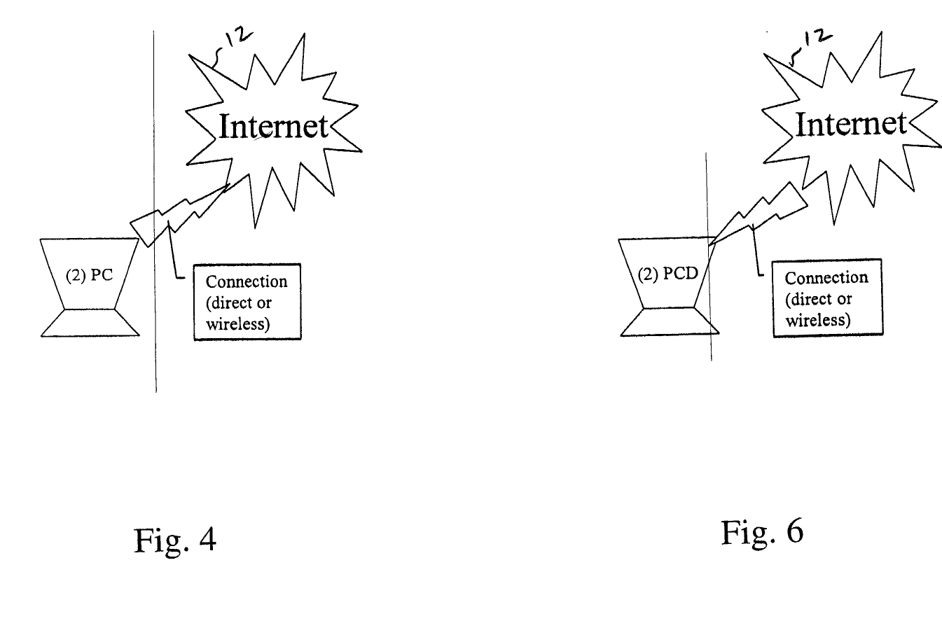

FIG. 4 illustrates upload to a server of data initially uploaded to a personal computing device in accord with a preferred embodiment. The data, as reformatted by the personal computing device 2 is uploaded via the network 12, e.g., the internet, to a server 10. The server 10 preferably will interpret the data as a request for a follow-up action.

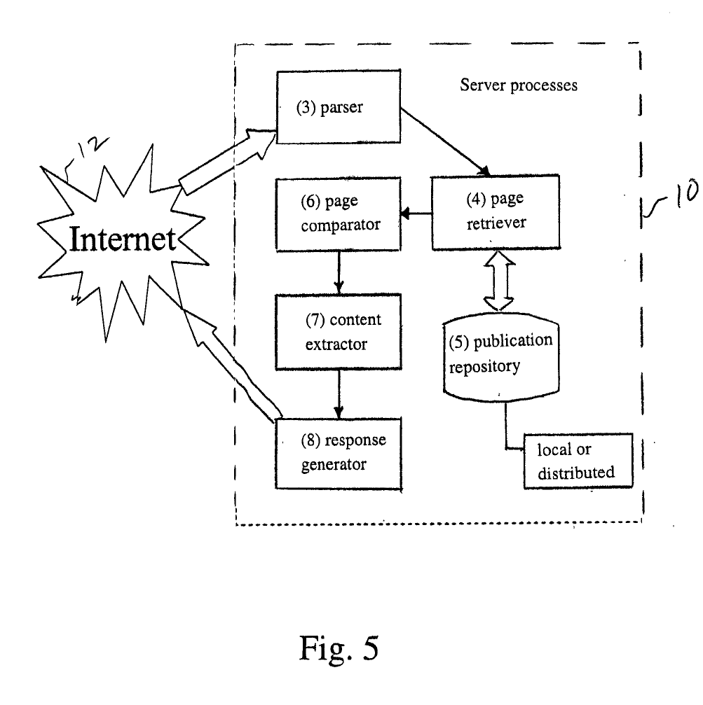

FIG. 5 illustrates receipt of data at a server in accord with a preferred embodiment. The data is received from the network 12 by the server 10. the server 10 identifies the transaction by the service subscriber ID and manages the transaction queue. The server 10 is a computer including a processor which runs on instructions provided in software stored in memory available to the processor, and preferably stored in non-volatile memory on the server 10. The software includes a parser 3, a page retriever 4, a publication repository 5 which may be local and/or distributed and may include one or more databases, a page comparator 6, a content extractor 7 and a response generator 8.

The request is parsed at the parser 3 to identify the publication, the issue/edition, the page and the type of feature captured. If the captured page number is an image fragment, the page number may be processed by character recognition. If the captured data is audio and the subject document is text, the audio may be processed by speech recognition. The relevant page or pages of the subject publication's subject issue/edition is retrieved using the page retriever 4.

The publication repository 5 may be centrally stored or distributed. The publication repository 5 may be local to the server 10 or the repository 5 may be remote, such as may be accessed via a network. A hybrid solution is quite possible, with some publications in a local, central repository and other accessed remotely.

The relevant page from the repository, in a layout preserving format such as PDF, is compared to the feature data in the request using the page comparator 6. Text matching, image convolution and other recognition techniques may be employed to identify the parts of the page corresponding to the captured features.

Once the parts of the page corresponding to the captured features have been identified, they are interpreted as requests for content, and the content is extracted at the content extractor 7. For example, a word on a page may be assumed to be a request to retrieve the article that contains the word and to flag the word as a keyword for indexing. A string or a lone page number may be a request to hyperlink to other web content.

The interpreted request ant the corresponding content are converted into a response at the response generator 8. this can be a direct response to the subscriber, e.g., “here is the article you requested.” It can also be a redirection of the response to another content source on the web, e.g., “please send the following item(s) to the user at the following address.” The formatted response is transmitted via the network 10, either to the subscriber directly or to the third party content provider. If the response involves retrieving content from a third party, the request is fulfilled by the third party and transmitted onto the network.

FIG. 6 illustrates response document delivery to the personal computing device 2 in accord with a preferred embodiment. The requested content arrives at the subscriber's PCD 2. Part of the proprietary software on the PCD 2, or on a central web server acting as an application service provider, is a set of utilities for the storage and management of the retrieved content, including indexing by keywords and other terms, distribution to email routing lists, etc.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the operations have been ordered in selected typographical sequences. However, the sequences have been selected and so ordered for typographical convenience and are not intended to imply any particular order for performing the operations, except for those claims wherein a particular ordering of steps is expressly set forth or understood by one of ordinary skill in the art as being necessary.

What is claimed is:

1. A software program running on a content server computer having access to a content repository, the program providing instructions for one or more processors of the server computer to perform the steps of:
receiving a content retrieval request in the form of a digital data representation of at least one physical feature of the requested content and captured from the document by a data capture device;
parsing the data to identify the content from the digital data representation;
retrieving the content from the content repository;
comparing the content retrieved to the at least one physical feature of the content requested;
extracting the content requested from the content retrieved; and
responding to the content retrieval request.

2. The software program of claim 1, wherein the data capture device includes an OCR wand.

3. The software program of claim 1, wherein the content is unencoded with any document identifier other than physical features of the content including the at least one physical feature captured with the data capture device.

4. The software program of claim 1, wherein the content of the content repository is indexed according to physical features of the content.

5. A method of retrieving content from a content repository, comprising the operations:
capturing at least one physical feature of a requested content with a data capture device;
uploading a digital representation of the at least one physical feature of the requested content to a personal computing device;
sending a request over a network to a content server having access to a content repository, which content server retrieves the content from the content repository; and
receiving a response from the server including the requested content.

6. The method of claim 5, wherein the data capture device includes an OCR wand.

7. The method of claim 5, wherein the content is unencoded with any document identifier other than physical features of the content including the at least one physical feature captured with the data capture device.

8. The method of claim 5, wherein the content of the content repository is indexed according to physical features of the content.

9. A software program running on a personal computing device having access to a network, the program providing instructions for one or more processors of the personal computing device to perform the steps of:
uploading a digital representation of at least one physical feature of a requested content from a data capture device;
sending a request over a network to a content server having access to a content repository, which content server retrieves the content from the content repository; and
receiving a response from the server including the requested content.

10. The software program of claim 9, wherein the data capture device includes an OCR wand.

11. The software program of claim 9, wherein the content is unencoded with any document identifier other than physical features of the content including the at least one physical feature captured with the data capture device.

12. The software program of claim 9, wherein the content of the content repository is indexed according to physical features of the content.

13. A method of storing and indexing a content repository, comprising the operations:
indexing content according to physical features of the content; and
storing the content in the content repository, wherein the content is unencoded with any document identifier other than the physical features of the content.

14. A method of retrieving content from a content repository, comprising the operations:
receiving a content retrieval request in the form of a digital data representation of at least one physical feature of the requested content and captured from the document by a data capture device;
parsing the data to identify the content from the digital data representation;
retrieving the content from the content repository;
comparing the content retrieved to the at least one physical feature of the content requested;
extracting the content requested from the content retrieved; and
responding to the content retrieval request.

15. The method of claim 14, wherein the data capture device includes an OCR wand.

16. The method of claim 14, wherein the content is unencoded with any document identifier other than physical features of the content including the at least one physical feature captured with the data capture device.

17. The method of claim 14, wherein the content of the content repository is indexed according to physical features of the content.
